(19) United States
(12) Patent Application Publication
(10) Pub. No.: US 2006/0046012 A1
(43) Pub. Date: Mar. 2, 2006

(54) Coating liquid, optical recording medium and method for producing the same

(75) Inventors: Junji Tanabe, Tokyo (JP); Atsushi Monden, Tokyo (JP); Masahiro Shinkai, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/104,592

(22) Filed: Apr. 13, 2005

(30) Foreign Application Priority Data
Apr. 21, 2004 (JP) P2004-126075

(51) Int. Cl. B05D 5/06; C01B 25/00; B32B 3/02

(52) U.S. Cl. 428/64.4; 427/162; 106/287.26

(57) ABSTRACT

The present invention aims to provide a coating liquid for producing an optical recording medium that can record large volumes of data and can respond sufficiently to high speed writing, a method for producing an optical recording medium using the same, and an optical recording medium. The coating liquid for use in a method for producing an optical recording medium according one embodiment of the invention contains a solvent and a pigment dissolved in the solvent. The solvent includes TFP and/or OFP and an aliphatic saturated alcohol having 1-4 carbon atoms by 0.01-10% by mass relative to the total amount of the solvent, and the pigment includes the compound represented by the following general formula (1) and a chelate compound consisting of an azo compound and a metal. 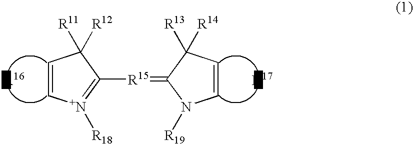
[where, each of R¹¹, R¹², R¹³ and R¹⁴ (hereinafter, represented as “R¹¹-R¹⁴”) represents independently from one another a benzyl group that may have a substituent or an alkyl group having 1-4 carbon atoms, R¹⁵ represents a trimethine chain that may have a substituent, each of R¹⁶ and R¹⁷ represents independently from each other a group of atoms that constitute a benzene ring that may have a substituent or a naphthalene ring that may have a substituent, and each of R¹⁸ and R¹⁹ represents independently from each other an aryl group that may have a substituent or an alkyl group having 1-4 carbon atoms, provided that at least one group among R¹¹, R¹², R¹³ and R¹⁴ is not a methyl group. In this case, respective carbons of R¹¹ and R¹² and/or R¹³ and R¹⁴ may make a bond to form a 3- to 6-membered ring.]

### BACKGROUND OF THE INVENTION

1. Field of the Invention

The invention relates to a coating liquid for use in production of an optical recording medium, a method for producing an optical recording medium using the coating liquid, and an optical recording medium obtained according to the method.

2. Related Background of the Invention

An optical recording medium is a recording medium in which information is recorded by irradiating laser light or the like to a recording layer to induce change of the recording layer in shape, magnetic domain or phase. As such an optical recording medium, there is known a disc-like optical recording medium with a recording layer containing an organic pigment formed on a support. An optical recording medium provided with a recording layer containing a pigment can perform highly-sensitive recording, and is widely prevalent as CD-R or DVD±R.

As for organic pigment for use in an optical recording medium, cyanine pigment, phthalocyanine pigment, azo metal pigment and the like are used. These pigments are dissolved in an organic solvent to be a coating liquid, and are coated on a support in such a coating liquid state by a coating method such as a spin coating method. Thus, a recording layer including the pigment is formed (layered) on a support. As for an organic solvent used for preparing the coating liquid, various organic solvents are known. Among them, halogenated alcohol, in particular fluorinated alcohol is often used because of its good dissolvability of the pigment.

However, a coating liquid using the aforementioned fluorinated alcohol tends to have poor wettability for a support. Accordingly, when use amount of a coating liquid is reduced, uniform coating on a support becomes difficult, whereby sometimes a coating defect generates such that a portion, on which no coating liquid is coated, occurs. On the other hand, when the use amount of coating liquid is increased in order to suppress the coating defect, a high discharging pressure is required to discharge the coating liquid, thereby leading easily to give uneven thickness in a recording layer. Generation of such coating defect or uneven thickness in a recording layer tends to lower properties of an optical recording medium such as sensitivity thereof. In addition, from a standpoint of reducing production cost, it is preferred to use as small amount of the coating liquid as possible at production of an optical recording medium because the pigment for use in a recording layer of the optical recording medium is expensive.

In order to resolve such disadvantages, a method is known in which a mixed solvent of tetrafluoropropanol and/or octafluoropropanol and an aliphatic saturated alcohol having from 1 to 4 carbons is used as a solvent for use in a coating liquid (see JP-A-11-339334). Use of such mixed solvent makes it possible to improve wettability of a coating liquid for a support, thereby hardly allowing a coating defect to generate even when the amount of a coating liquid is reduced.

### SUMMARY OF THE INVENTION

Incidentally, such an optical recording medium as described above is required to have such properties that it enables performing a high speed data recording (writing) and, further, represents low writing mistakes even when such high speed writing is performed. The optical recording medium produced by the aforementioned conventional method is sufficiently provided with such properties.

However, along with recent trend of highly-networked information, necessity for recording ever-larger amounts of data has increased for an optical recording medium. In order to answer such large amount recording, mainstream of an optical recording medium is rapidly evolving form conventional CD-R (recording/reproducing wavelength 750-830 nm) into DVD±R (recording/reproducing wavelength 620-690 nm) that enables recording data in a higher density. Under the circumstances, an optical recording medium is required to have such properties that it can answer a further high speed writing than ever before in order to easily deal with even data of large volumes.

The present invention was accomplished with the view to the aforementioned circumstances, and aims to provide a coating liquid for producing an optical recording medium that can answer data recording of large volumes and, further, also a high speed writing sufficiently, a method for producing an optical recording medium using the same, and an optical recording medium obtained by the method.

As a result of intensive studies on achieving the object, the present inventors found that use of a coating liquid containing a pigment including a cyanine-based compound with a certain structure enables formation of a recording layer that can answer data recording of large volumes and, further, hardly generates writing mistakes even when a high speed writing is performed, to accomplish the invention.

That is, the coating liquid according to the invention is a coating liquid for forming a recording layer of an optical recording medium, the coating liquid containing a solvent and a pigment dissolved in the solvent, wherein the solvent comprises tetrafluoro propanol and/or octafluoro pentanol and an aliphatic saturated alcohol having from 1 to 4 carbon atoms by 0.01-10% by mass relative to the total amount of the solvent and the pigment comprises a compound represented by the following general formula (1) and a chelate compound consisting of an azo compound and a metal: 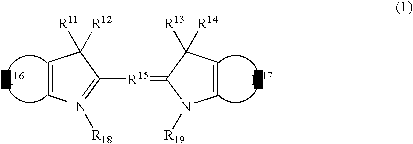
[where, each of R¹¹, R¹², R¹³ and R¹⁴ (hereinafter, represented as “R¹¹-R¹⁴”) represents independently from one another a benzyl group that may have a substituent or an alkyl group having 1-4 carbon atoms, R¹⁵ represents a trimethine chain that may have a substituent, each of R¹⁶ and R¹⁷ represents independently from each other a group of atoms that constitute a benzene ring that may have a substituent or a naphthalene ring that may have a substituent, and each of R¹⁸ and R¹⁹ represents independently from each other an aryl group that may have a substituent or an alkyl group having 1-4 carbon atoms, provided that at least one group among R¹¹, R¹², R¹³ and R¹⁴ is not a methyl group. In this case, respective carbons of R¹¹ and R¹² and/or R¹³ and R¹⁴ may make a bond to form a 3- to 6-membered ring.]

In order to answer the aforementioned high speed writing, an optical recording medium is required to be affected by an extremely little thermal interference. Here, the thermal interference means a phenomenon shown below. Writing of data and the like to an optical recording medium is performed by irradiating laser light to a recording layer to heat the pigment, thereby forming pits on the recording layer. Upon formation of such pits, when rotation speed of the optical recording medium is raised in order to perform high speed writing, heat used for forming a preceding pit tends not to diffuse sufficiently before a subsequent pit is formed. In this case, a phenomenon (thermal interference) generates in which remaining heat of a preceding pit interferes with writing of a subsequent pit. Generation of such thermal interference tends to induce such disadvantage that distance between pits or length of pits shifts from a desired shape.

The recording layer formed by using the aforementioned coating liquid of the invention is one that hardly generates such disadvantage as the thermal interference. That is, the coating liquid contains a compound represented by the aforementioned general formula (1) as the pigment. The compound has at least one alkyl group having 2 or more carbon atoms or one benzyl group that may have a substituent in a group represented by R¹¹-R¹⁴. The pigment having the structure is one that extremely tends to generate heat diffusion after heating. Accordingly, it is considered that a recording layer formed by using a coating liquid containing the pigment becomes one that hardly generates the aforementioned thermal interference. However, the effect is not limited to this.

The coating liquid of the invention contains a mixed solvent comprising tetrafluoro propanol and/or octafluoro pentanol and an aliphatic saturated alcohol having 1-4 carbon atoms as a solvent. The coating liquid using such mixed solvent has an excellent wettability for a support of an optical recording medium, as described above. Therefore, according to the coating liquid, uniform coating on the support is possible even with a small use amount, whereby coating defect and the like tend to hardly generate. As the result, it becomes possible to reduce considerably property reduction of an optical recording medium caused by such coating defect or unevenness of recording layer thickness, and also to lower production cost of an optical recording medium.

Further, the compound represented by the aforementioned general formula (1) contained in the aforementioned coating liquid of the invention is one having excellent properties of absorbing laser light having a wavelength for recording/reproducing in the aforementioned recording medium of large capacity such as DVD±R. Accordingly, the optical recording medium provided with a recording layer comprising the compound becomes one that enables high-density (large volume) recording and, further, has excellent sensitivity.

Furthermore, the optical recording medium obtained by using the coating liquid of the invention becomes one that shows an excellent reflectivity. Usually, a chamfer (groove) is formed on a support for use in an optical recording medium to guide the laser light for writing. In this relation, since the coating liquid of the invention has a good wettability for support surface as described above, uniform coating can be performed on the support surface that has such irregularity. As the result, the recording layer is formed in a shape along the irregularity of the support to become one capable of exerting a good reflectivity.

The aforementioned coating liquid of the invention preferably contains isopropyl alcohol as the aliphatic saturated alcohol. When this is done, wettability of the coating liquid for a support is further enhanced, making it possible to form better a recording layer in an optical recording medium.

Further, in a compound represented by the aforementioned general formula (1), preferably at least one group among R¹¹, R¹², R¹³ and R¹⁴ is a benzyl group that may have a substituent. A compound (pigment) having such structure is one that is further excellent in properties of diffusing heat after heating. This makes it possible to give an optical recording medium with further reduced effect of the thermal interference.

The method for producing an optical recording medium according to the invention is a method in which the aforementioned coating liquid of the invention is preferably used, the method being characterized by comprising the process of coating a coating liquid containing a solvent and a pigment dissolved in the solvent on a support, wherein a solvent comprising tetrafluoro propanol and/or octafluoro pentanol and an aliphatic saturated alcohol having 1-4 carbon atoms by 0.01-10% by mass relative to the total amount of the solvent is used as the solvent and a pigment comprising a compound represented by the following general formula (1) and a chelate compound consisting of an azo compound and a metal is used as the pigment: 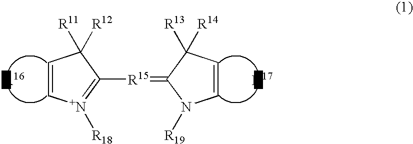
[where, each of R¹¹, R¹², R¹³ and R¹⁴ represents independently from one another a benzyl group that may have a substituent or an alkyl group having 1-4 carbon atoms, R¹⁵ represents a trimethine chain that may have a substituent, each of R¹⁶ and R¹⁷ represents independently from each other a group of atoms that constitute a benzene ring that may have a substituent or a naphthalene ring that may have a substituent, and each of R¹⁸ and R¹⁹ represents independently from each other an aryl group that may have a substituent or an alkyl group having 1-4 carbon atoms, provided that at least one group among R¹¹, R¹², R¹³ and R¹⁴ is not a methyl group. In this case, respective carbons of R¹¹ and R¹² and/or R¹³ and R¹⁴ may make a bond to form a 3- to 6-membered ring.]

Since the optical recording medium obtained according to the production method is one having a recording layer formed from the aforementioned coating liquid of the invention, as described above, it hardly generates the thermal interference even when a high speed writing is performed and, further, becomes excellent in properties of sensitivity and reflectivity.

In the coating liquid for use in the aforementioned method, isopropyl alcohol is preferred as the aliphatic saturated alcohol included in the solvent. As for the compound represented by the general formula (1), at least one group among R¹¹, R¹², R¹³ and R¹⁴ is preferably a benzyl group that may have a substituent.

The optical recording medium is obtained by the aforementioned production method. In other words, the recording medium of the invention is provided with a support and a recording layer disposed on the support, wherein the recording layer is formed through a process of coating a coating liquid containing a solvent and a pigment dissolved in the solvent on the support, characterized in that a solvent comprising tetrafluoro propanol and/or octafluoro pentanol and an aliphatic saturated alcohol having 1-4 carbon atoms by 0.01-10% by mass relative to the total amount of the solvent is used as the solvent, and a compound represented by the following general formula (1) and a chelate compound consisting of an azo compound and metal is used as the pigment: 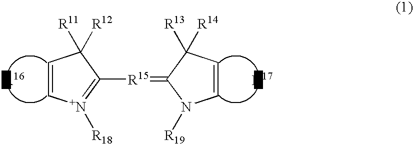
[where, each of R¹¹, R¹², R¹³ and R¹⁴ represents independently from one another a benzyl group that may have a substituent or an alkyl group having 1-4 carbon atoms, R¹⁵ represents a trimethine chain that may have a substituent, each of R¹⁶ and R¹⁷ represents independently from each other a group of atoms that constitute a benzene ring that may have a substituent or a naphthalene ring that may have a substituent, and each of R¹⁸ and R¹⁹ represents independently from each other an aryl group that may have a substituent or an alkyl group having 1-4 carbon atoms, provided that at least one group among R¹¹, R¹², R¹³ and R¹⁴ is not a methyl group. In this case, respective carbons of R¹¹ and R¹² and/or R¹³ and R¹⁴ may make a bond to form a 3- to 6-membered ring.]

### BRIEF DESCRIPTION OF THE DRAWINGS

FIG. 1 is a view that shows schematically the cross-sectional structure of an optical recording medium produced according to the production method of the embodiment.

FIG. 2 is a view that shows the cross-sectional structure of an optical recording medium provided with a recording layer on one side of the support.

### DESCRIPTION OF THE PREFERRED EMBODIMENTS

Hereinafter, preferred embodiments of the present invention will be described in detail while referring to the drawings. Here, the same elements will be given with the same symbols and overlapping description will be omitted. Further, positional relation such as top, bottom, left or right is intended to be based on the positional relation in the drawing.

[Coating Liquid]

A coating liquid according to a preferred embodiment is one that comprises a solvent and a pigment dissolved in the solvent, which contains, as the solvent, tetrafluoro propanol and/or octafluoro pentanol and an aliphatic saturated alcohol having 1-4 carbon atoms by 0.01-10% by mass relative to the total amount of the solvent and, as the pigment, a compound represented by the aforementioned general formula (1) and a chelate compound consisting of an azo compound and a metal.

<Solvent>

First, description will be given about the solvent included in the coating liquid. As for the tetrafluoro propanol (hereinafter, abbreviated as “TFP”) included in the solvent, 2,2,3,3-tetrafluoro-1-propanol is preferred. As for the octafluoro pentanol (hereinafter, abbreviated as “OFP”), 2,2,3,3,4,4,5,5-octafluoro-1-pentanol is preferred. Each of TFP and OFP may be used individually, or may be used by combining them at an arbitrary ratio. Further, examples of the aliphatic saturated alcohol having 1-4 carbon atoms include methanol, ethanol, 1-propanol, 2-propanol, butanol and 2-butanol. Among them, methanol, ethanol, 1-propanol or 2-propanol are preferred. A mixture of two or more kinds of these may be contained as the aliphatic saturated alcohol.

In the solvent, content of the aliphatic saturated alcohol relative to the total amount of the solvent is 0.01-10% by mass. The content of 0.05-5% by mass is more preferred. Content of the aliphatic saturated alcohol less than 0.01% by mass gives an insufficient wettability of a coating liquid for a support to require large amounts of the coating liquid in order to perform uniform coating on the support. On the other hand, the content more than 10% by mass results in lowering of solubility for the compound represented by the aforementioned general formula (1), which is a pigment, whereby the compound tends to precipitate.

The solvent included in the coating liquid may comprise a liquid other than TFP, OFP and an aliphatic saturated alcohol. Such other liquid may be incorporated in the solvent by around 1% by mass.

<Compound Represented by the General Formula (1)>

Next, description will be given about a pigment included in the coating liquid. First, the compound represented by the aforementioned general formula (1), which is included in pigment, is a compound referred to as a cyanine-based compound. In the compound, each of R¹¹-R¹⁴ is, independently from one another, a benzyl group that may have a substituent or an alkyl group having 1-4 carbon atoms, where not all of them are methyl groups.

Here, examples of the alkyl group having 1-4 carbon atoms that constitutes a group represented by R¹¹-R¹⁴ include a methyl group, an ethyl group, a propyl group, an isoporpyl group, a butyl group, a s-butyl group, a t-butyl group and an isobutyl group. Further, in R¹¹ and R¹² and/or R¹³ and R¹⁴ when both in respective combinations are alkyl groups having 1-4 carbon atoms, respective carbon atoms in the alkyl groups may make a bond to form a 3- to 6-membered ring. In a preferred case, at least one among groups represented by R¹¹, R¹², R¹³ and R¹⁴ is a benzyl group that may have a substituent, and more preferably it is a benzyl group.

Further, R¹⁵ is a trimethine chain that may have a substituent, wherein examples of the substituent of the chain include a halogen atom, an alkyl group having 1-8 carbon atoms, an aryl group that may have a substituent, an alkoxy group, an alkylthio group, a nitro group and a cyano group. As for R¹⁵, a group having no these substituents is preferred.

Furthermore, each of R¹⁸ and R¹⁹ is an aryl group that may have a substituent or an alkyl group having 1-4 carbon atoms, and they may be same with or different from each other. Among them, each of R¹⁸ and R¹⁹ is preferably an alkyl group having 1-4 carbon atoms, and more preferably a methyl group.

As for the compound having the above-described structure represented by the aforementioned general formula (1), those shown below are exemplified. Hereinafter, description will be given according to classification based on every combination of groups represented by R¹⁶ and R¹⁷. As the compound represented by the general formula (1), compounds falling in the following classification may be arbitrarily selected to use.

(Compound in Which Both of R¹⁶ and R¹⁷ are Benzene Rings)

First, examples of the compound in which both of R¹⁶ and R¹⁷ are benzene rings that may have a substituent include those represented by the following general formula (4).

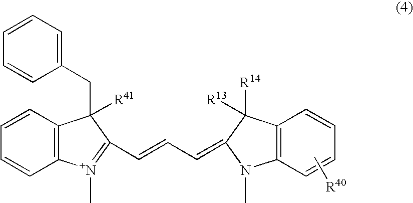

In the formula, R¹³ and R¹⁴ have the same meaning as that described above, R⁴⁰ represents a hydrogen atom, an alkyl group having 1-3 carbon atoms, an alkoxy group having 1-3 carbon atoms, a halogen atom, a cyano group or a nitro group, and R⁴¹ represents a methyl group or a benzyl group that may have a substituent. When R⁴¹ is a methyl group for example, examples of the compound include such a compound having a combination in which either one of R¹³ and R¹⁴ is an alkyl group and the other is a benzyl group that may have a substituent, or a compound in which both of R¹³ and R¹⁴ are alkyl groups having 1-4 carbon atoms wherein respective carbon atoms make a bond to form a 3- to 6-membered ring. For example, compounds represented by the following chemical formulae (5a)-(5d) are preferred. On the other hand, when R⁴¹ is a benzyl group that may have a substituent, a compound represented by the following chemical formula (5e), which is led when both of R¹³ and R¹⁴ are benzyl groups that may have a substituent, is preferred.

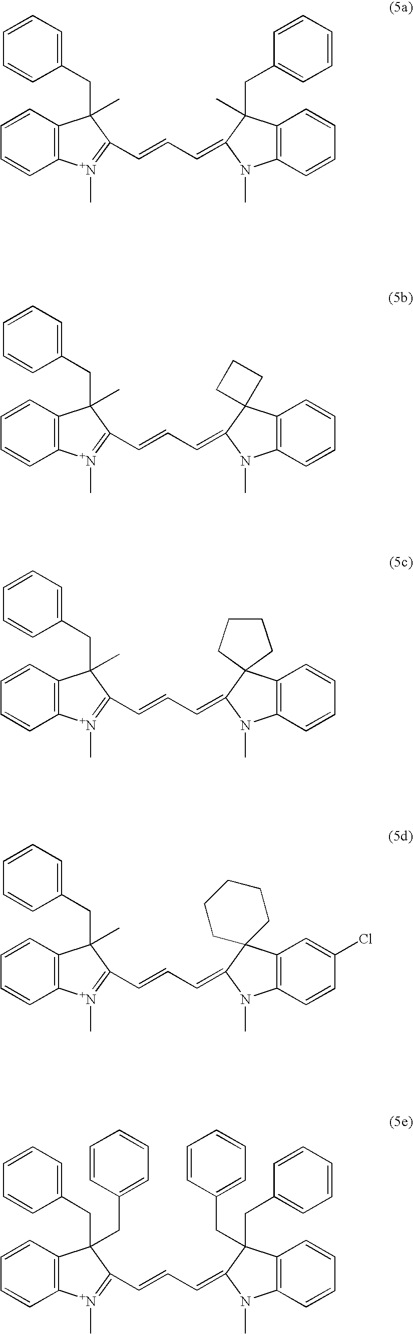

(Compound in Which R¹⁶ is a Benzene Ring and R¹⁷ is a Naphthalene Ring)

In the compound represented by the aforementioned general formula (1), examples of the compound, wherein R¹⁶ is a benzene ring that may have a substituent and R¹⁷ is a naphthalene ring that may have a substituent, include the compound represented by the following general formula (6).

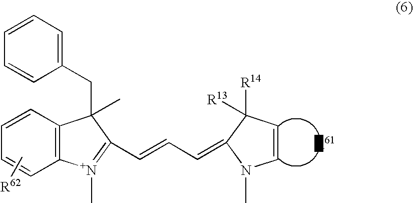

In the formula, R¹³ and R¹⁴ represent the same meaning as that described above, R⁶¹ represents a group of atoms constituting a naphthalene ring that may have a substituent, R⁶² represents a hydrogen atom, an alkyl group having 1-3 carbon atoms, an alkoxy group having 1-3 carbon atoms, a halogen atom, a cyano group or a nitro group. As for the compound represented by the aforementioned general formula (6), preferred one has a combination in which both of R¹³ and R¹⁴ are methyl groups, or a combination in which one is a methyl group and the other is an ethyl group. Examples of the compound include compounds represented by the following chemical formulae (7a)-(7f).

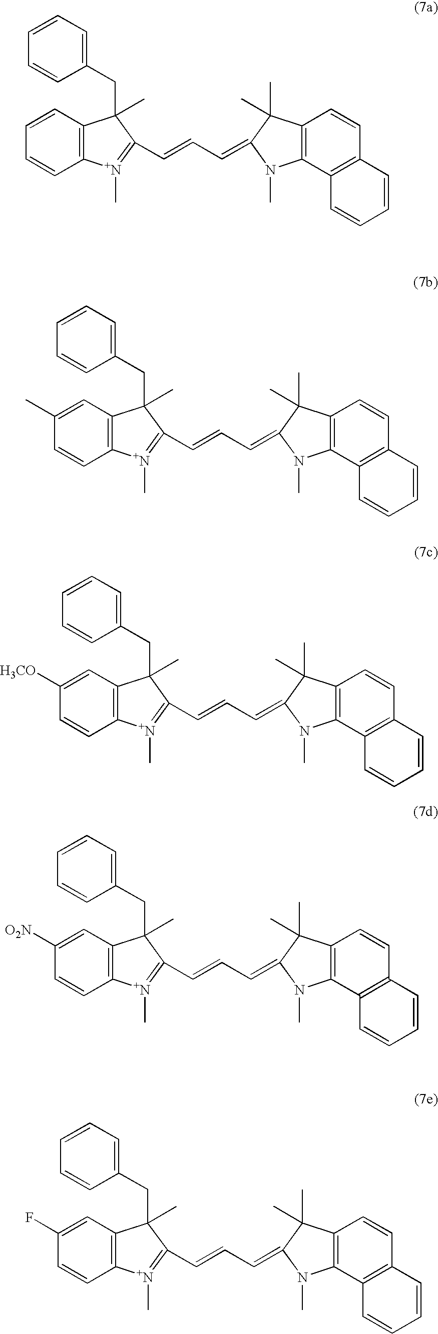

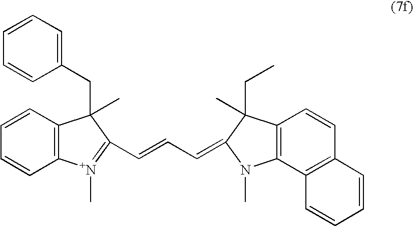

As for the compound represented by the aforementioned general formula (6), a compound in which both of R¹³ and R¹⁴ are alkyl groups having 1-4 carbon atoms wherein respective carbon atoms make a bond to form a 3- to 6-membered ring is also preferred. Examples of the compound include compounds represented by the following chemical formula (8a) or (8b).

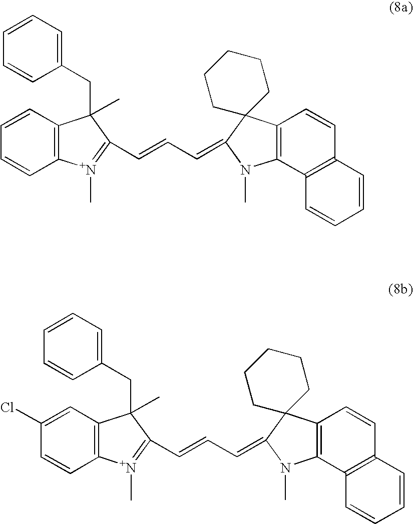

(Compound in Which R¹⁶ is a Naphthalene Ring and R¹⁷ is a Benzene Ring)

Among the compound represented by the aforementioned general formula (1), examples of the compound in which R¹⁶ is a naphthalene ring that may have a substituent and R¹⁷ is a benzene ring that may have a substituent include the compound represented by the following general formula (9).

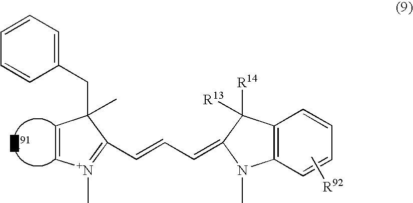

In the formula, R¹³ and R¹⁴ represent the same meaning as that described above, R⁹¹ represents a group of atoms constituting a naphthalene ring that may have a substituent, R⁹² represents a hydrogen atom, an alkyl group having 1-3 carbon atoms, an alkoxy group having 1-3 carbon atoms, a halogen atom, a cyano group or a nitro group. As for the compound represented by the aforementioned general formula (9), a preferred compound has a combination in which both of R¹³ and R¹⁴ are methyl groups, a combination in which one of them is a methyl group and the other is an ethyl group or a n-propyl group, or a combination in which both of them are ethyl groups. Examples of the compound include compounds represented by the following chemical formulae (10a)-(10e).

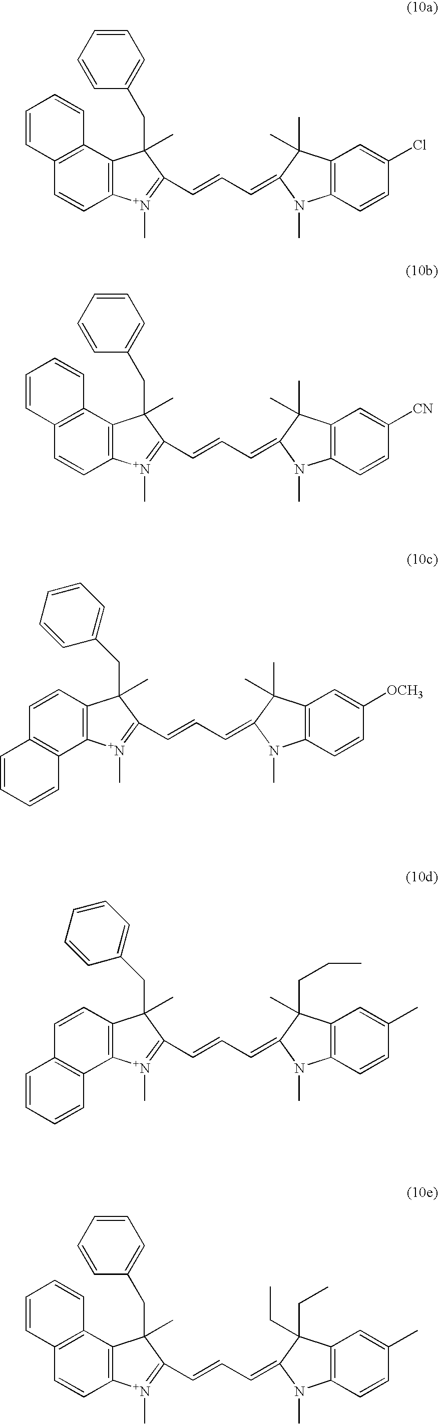

As for the compound represented by the aforementioned general formula (9), one having a combination in which one of R¹³ and R¹⁴ is a methyl group and the other is a benzyl group that may have a substituent is also preferred. Examples of the compound include compounds represented by the following chemical formula (11a) or (11b).

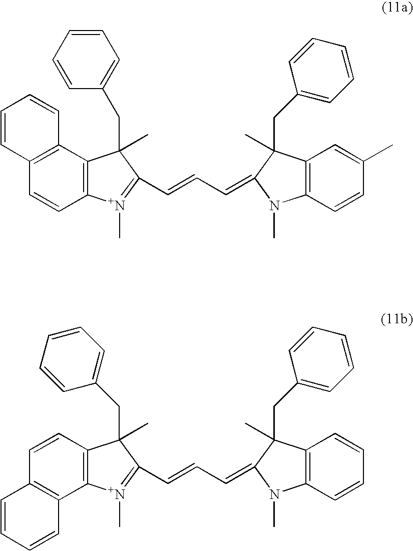

In addition, as for the compound represented by the aforementioned general formula (9), compounds in which both of R¹³ and R¹⁴ are benzyl groups that may have a substituent are also preferred. Example of the compound includes a compound represented by the following chemical formula (12).

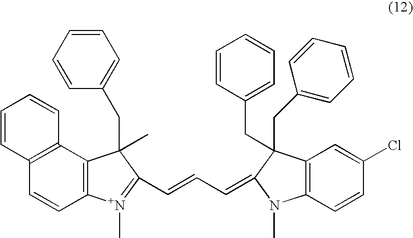

(Compound in Which Both of R¹⁶ and R¹⁷ are Naphthalene Rings)

Among the compound represented by the aforementioned general formula (1), examples of the compound in which both of R¹⁶ and R¹⁷ are naphthalene rings that may have a substituent include the compound represented by the following general formula (13).

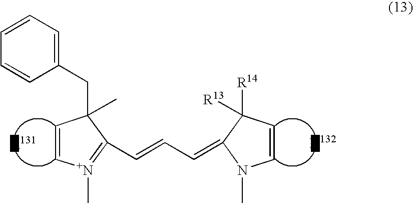

In the formula, R¹³ and R¹⁴ represent the same meaning as that described above, and R¹³¹ and R¹³² represent a group of atoms constituting a naphthalene ring that may have a substituent. As for the compound having such structure, preferred compounds are those having a combination in which both of R¹³ and R¹⁴ are methyl groups, a combination in which one of them is a methyl group and the other is a benzyl group that may have a substituent, and a combination in which both of them are alkyl groups having 1-4 carbon atoms and respective carbon atoms make a bond to form a 3- to 6-membered ring. Among them, a combination in which both of them are methyl groups, or a combination in which a 3- to 6-membered ring is formed is particularly preferred. As for the compound, those represented by the following chemical formulae (14a)-(14c) can be exemplified.

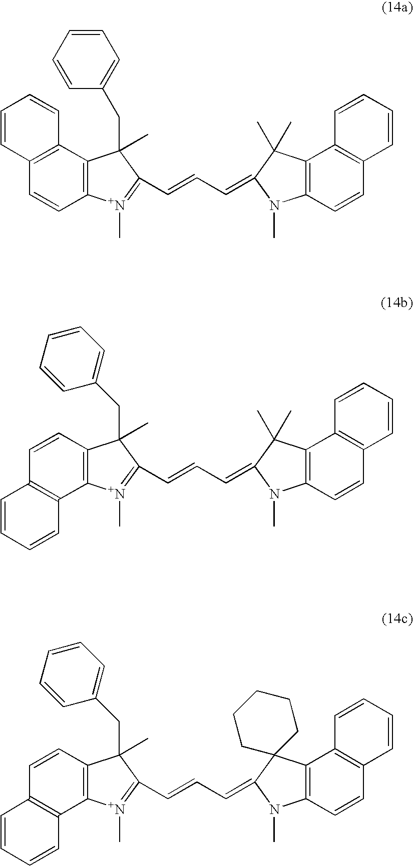

As for the compound to be incorporated as a cyanine-based compound, among those described above, the compound represented by the aforementioned chemical formula (12) or the compound represented by the aforementioned chemical formula (14a) is particularly preferred. These compounds have excellent properties for dispersing heat after the heating. Accordingly, by using a coating liquid including one of these compounds, it becomes possible to obtain an optical recording medium in which the thermal interference hardly ever generates.

In the coating liquid, the cyanine-based compound is contained in combination with a counter ion (counter anion) of the compound. Specific examples of such counter anions include halide ions (such as Cl⁻, Br⁻ and I⁻ and the like), ClO₄⁻, BF₄⁻, PF₆⁻, VO₃⁻, VO₄³⁻, WO₄²⁻, CH₃SO₃⁻, CF₃COO⁻, CH₃COO⁻, HSO₄⁻, CF₃SO₃⁻, p-toluensulfonic acid ion (PTS⁻), and p-trifluoromethylphenylsulfonic acid ion (PFS⁻). Among them, ClO₄⁻, BF₄⁻, PF₆⁻, SbF₆⁻ and the like are preferred.

<Chelate Compound>

The pigment included in the coating liquid contains, in addition to the aforementioned cyanine compound, a chelate compound (azo-based metal complex) consisting of an azo compound and a metal. As for such chelate compound, for example, a metal chelate compound formed by coordinating an azo compound having an azo group substituted by an aromatic ring with a metal can be mentioned. Such a compound is one which is also referred to as azo-based pigment, azo-based dye or the like. Those, for example, described in JP-A-9-323478, JP-A-10-081069, JP-A-03-268994 and the like may be applied. As for the azo compound constituting the chelate compound, the compound represented by the following general formula (15) can be mentioned.
R¹⁵¹—N═N—R¹⁵² (15)

In such compounds, R¹⁵¹ and R¹⁵² are aromatic rings, in which at least either one is an aromatic ring having a substituent capable of coordinating to a metal atom, or a nitrogen-containing heteroaromatic ring having a nitrogen atom capable of coordinating to a metal atom. These R¹⁵¹ and R¹⁵² may be same with or different from each other. Here, the substituent capable of coordinating to a metal atom and the nitrogen atom capable of coordinating to a metal atom are preferably located at a site adjacent to an azo group-substituted site (for example, the ortho site in the case of a benzene ring).

The aromatic ring constituting R¹⁵¹ and R¹⁵² may be a monocycle, or a polycycle such as a condensed polycycle or a ring-collected polycycle. Examples of the aromatic ring include a benzene ring, a naphthalene ring, a pyridine ring, a thiazole ring, a benzothiazole ring, an oxazole ring, a benzoxazole ring, a quinoline ring, an imidazole ring, a pyrazine ring, and a pyrrole ring. Among these, a benzene ring, a pyridine ring, a quinoline ring and a thiazole ring are particularly preferred.

As for a substituent capable of coordinating to a metal atom, a group having an active hydrogen can be mentioned. Examples of the group having an active hydrogen include —OH, —SH, —NH₂, —COOH, —CONH₂, —SO₂NH₂, —SO₃H and —NHSO₂CF₃. Among these, —OH is particularly preferred.

Further, R¹⁵¹ and R¹⁵² may have another substituent in addition to that described above. Respective substituents included in R¹⁵¹ and R¹⁵² may be same with or different from each other. When they are different from each other, a preferred case is that R¹⁵¹ includes at least one kind of group selected from the group consisting of a nitro group, a halogen atom (such as a chlorine atom or a bromine atom), a carboxyl group, a sulfo group, a sulphamoyl group and an alkyl group (preferably having 1-4 carbon atoms, more preferably a methyl group), and that R¹⁵² includes at least one kind of group selected from the group consisting of an amino group (preferably a dialkylamino group having 2-8 total carbon atoms, such as a dimethylamino group, a diethylamino group, a methylethylamino group, a methylpropylamino group, a dibutylamino group, or a hydroxyethylmethylamino group), an alkoxy group (preferably having 1-4 carbon atoms, such as a methoxy group), an alkyl group (preferably having 1-4 carbon atoms, more preferably a methyl group), an aryl group (preferably monocyclic, such as a phenyl group or a chlorophenyl group), a caoboxyl group and a sulfo group. In this connection, a substituent in R¹⁵¹ is preferably located at meta or para site relative to an azo group, more preferably at meta site.

As for a metal (central metal) constituting a chelate compound, a transition metal such as Co, Mn, Ti, V, Ni, Cu, Zn, Mo, W, Ru, Fe, Pd, Pt or Al and the like is preferred. Alternatively, V, Mo or W may be included as respective oxide ions such as VO²⁺, VO³⁺, MoO²⁺, MoO³⁺ or WO³⁺ and the like. Among these, VO²⁺, VO³⁺, Co, Ni or Cu are particularly preferred.

In these chelate compounds, usually coordination bonds are formed between the aforementioned azo compound as a tridentate ligand and a metal. In this connection, when the azo compound has a substituent including an active hydrogen, usually, the active hydrogen removes to give a tridentate ligand.

Such chelate compounds sometimes, as a whole, may be neutral, or may be an anion or a cation. When the chelate compound is an anion, it forms a salt with a counter cation thereof. As for the counter cation, metal cations such as Na⁺, Li⁺ and K⁺ and the like, an ammonium ion and a tetra-alkylammonium ion can be mentioned. Or, the aforementioned cyanine compound may be used as a counter cation to form a salt with the anion.

Specific examples of the chelate compound include those listed in the following Tables 1-6. They may be used individually or in combination of plural kinds. Here, in the chelate compounds listed in Tables 1-6, 2 azo compounds coordinate to 1 element of the central metal. In Tables, chelate compounds for which 2 kinds of azo compounds or central metals are listed, respectively, mean that they contain these at 1:1 ratio by mol. These chelate compounds may be obtained by synthesizing them according to a publicly known method (for example, refer to Furukawa, Anal. Chim. Acta., 140, p.289, 1982).

TABLE 1

| Chelate | | Central |
|---|---|---|
| compound | Azo compound | metal |
| A1 | 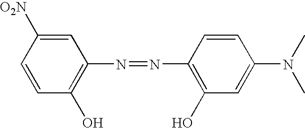 | Co |
| A2 | 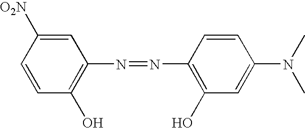 | V = O |
| A3 | 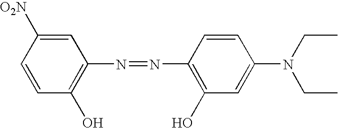 | Co |
| A4 | 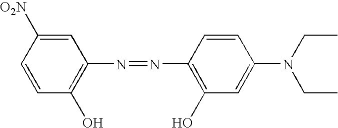 | V = O |
| A5 | 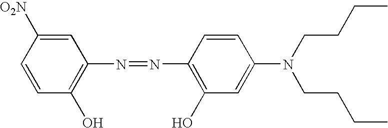 | Co |
| A6 | 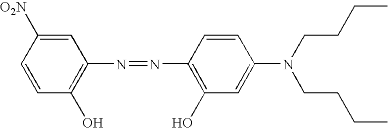 | V = O |
| A7 | 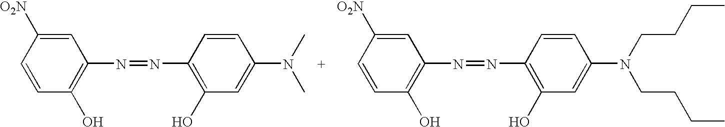 | Co |
| A8 | 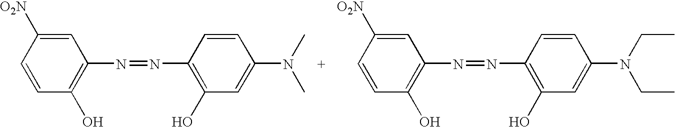 | Co |

TABLE 2

| Chelate | | Central |
|---|---|---|
| compound | Azo compound | metal |
| A9 | 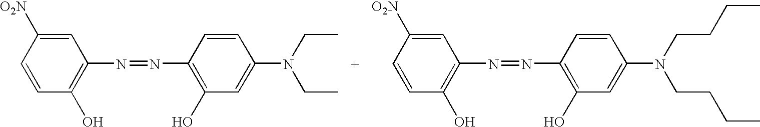 | Co |
| A10 | 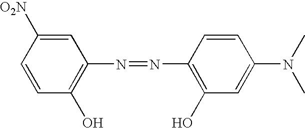 | Co +V = O 1:1 |
| A11 | 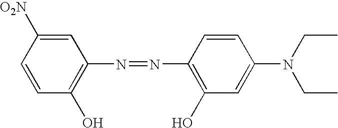 | Co +V = O 1:1 |
| A12 | 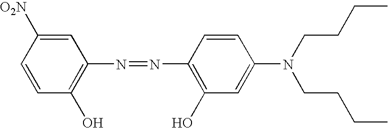 | Co +V = O 1:1 |
| A13 | 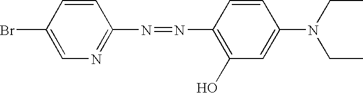 | Cu |
| A14 | 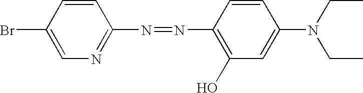 | Ni |
| A15 | 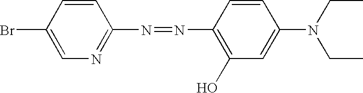 | Co |
| A16 | 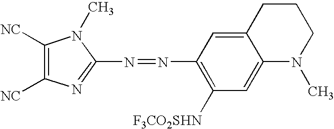 | Ni |
| A17 | 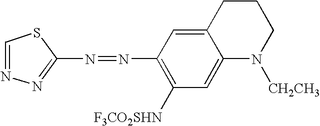 | Ni |

TABLE 3

| Chelate | | Central |
|---|---|---|
| compound | Azo compound | metal |
| A18 | 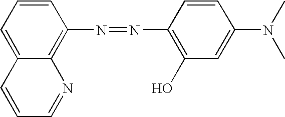 | Co |
| A19 | 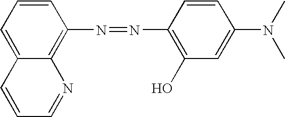 | Ni |
| A20 | 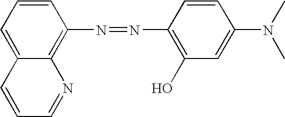 | Cu |
| A21 | 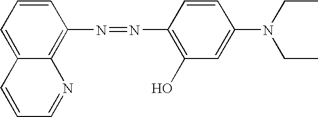 | Co |
| A22 | 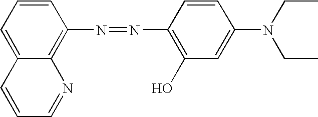 | Ni |
| A23 | 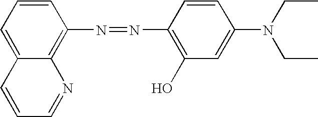 | Cu |
| A24 | 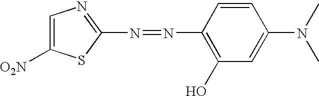 | Cu |
| A25 | 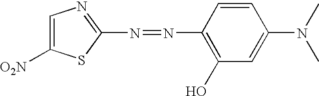 | Ni |
| A26 | 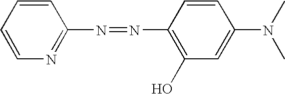 | Cu |
| A27 | 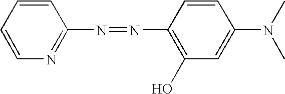 | Ni |

TABLE 4

| Chelate compound | Azo compound | Central metal |
|---|---|---|
| A28 | 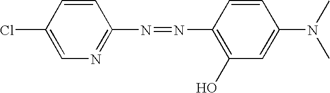 | Cu |
| A29 | 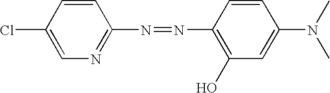 | Ni |
| A30 | 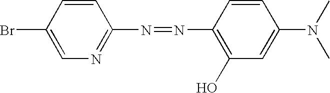 | Cu |
| A31 | 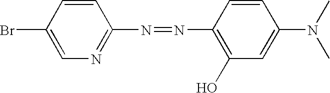 | Ni |
| A32 | 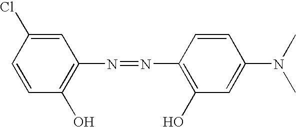 | Co |
| A33 | 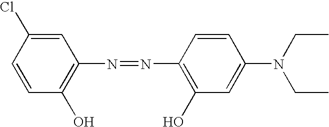 | Co |
| A34 | 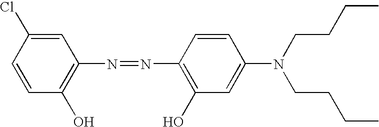 | Co |
| A35 | 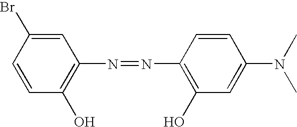 | Co |
| A36 | 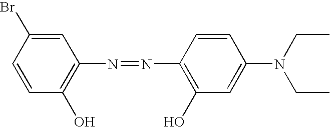 | Co |
| A37 | 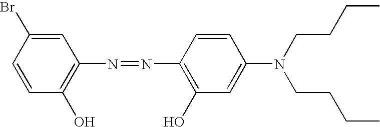 | Co |

TABLE 5

| Chelate compound | Azo compound | Central metal |
|---|---|---|
| A38 | 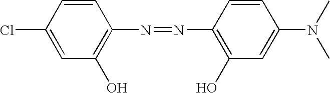 | Co |
| A39 | 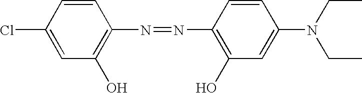 | Co |
| A40 | 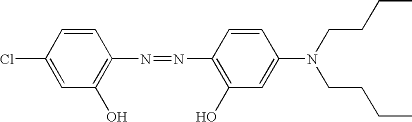 | Co |
| A41 | 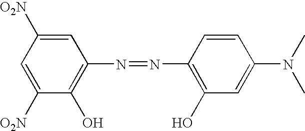 | Co |
| A42 | 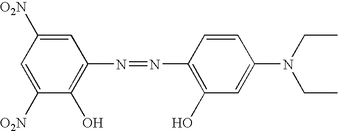 | Co |
| A43 | 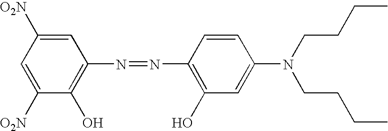 | Co |
| A44 | 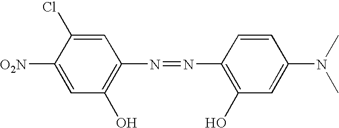 | Co |
| A45 | 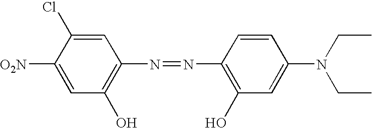 | Co |
| A46 | 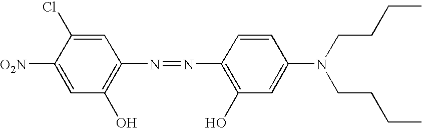 | Co |
| A47 | 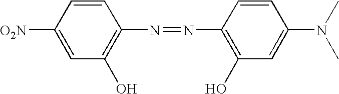 | Co |

TABLE 6

| Chelate compound | Azo compound | Central metal |
|---|---|---|
| A48 | 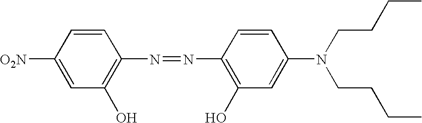 | Co |
| A49 | 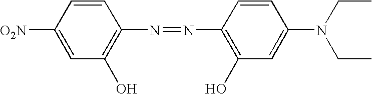 | Co |
| A50 | 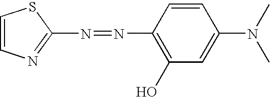 | Ni |
| A51 | 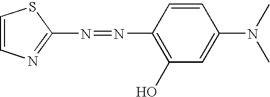 | Cu |

The aforementioned coating liquid may contain another kind of pigment as well in addition to the aforementioned cyanine-based compound and chelate compound. Examples of such another pigment include phthalocyanine pigment, formazan pigment, rhodamine pigment and triphenylmethane-series pigment. When these other pigments are incorporated, such compounding that content of the aforementioned cyanine-based compound is to be 30% by mol or more of the total pigment is preferred. The content of the cyanine-based compound less than 30% by mol tends to make it difficult to suppress sufficiently the thermal interference in an optical recording medium.

As for the content of the pigment in the coating liquid, it is preferred that the summed mass of the pigments relative to the total amount of the coating liquid is to be 0.5-50% by mass preferably, 0.6-10% by mass more preferably, and 0.8-5% by mass flurthermore preferably. When the summed content of the pigments is less than 0.5% by mass, pit formation on the recording layer by laser light irradiation tends to become difficult. On the other hand, when it is more that 50% by mass, precipitation of the pigment may occur at coating. The pigment thus precipitates easily becomes cause of defect in a recording layer.

Furthermore, in addition to these, the coating liquid may be suitably incorporated, for example, with a binder, a dispersing agent or a stabilizer.

[Method for Producing an Optical Recording Medium]

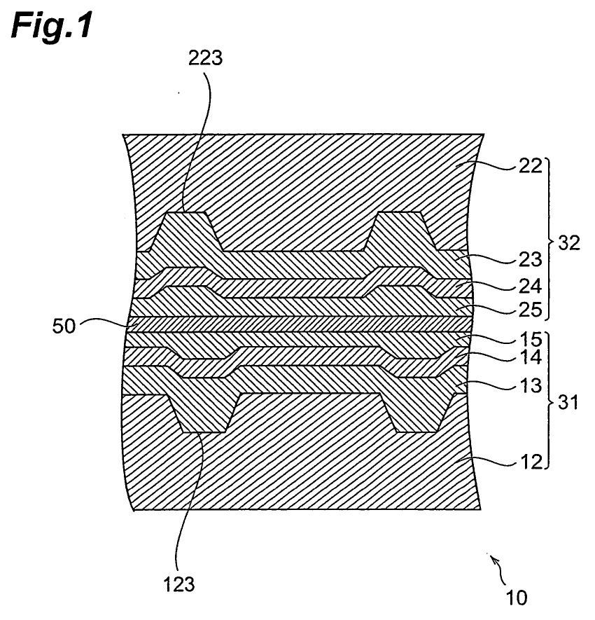

The method for producing an optical recording medium according to a preferable embodiment includes a process of coating the coating liquid of the aforementioned embodiment on a support. First, description will be given about a preferred embodiment of the optical recording medium obtained according to such production method. FIG. 1 is a drawing that schematically represents cross-sectional structure of an optical recording medium produced according to a production method of the embodiment. Optical recording medium 10 as shown in FIG. 1 is a write-once type optical recording compact disc corresponding to the DVD standard, for which recording/reproducing by light of a short wave length around 620-690 nm are possible.

The optical recording medium 10 has such a structure that a one surface optical recording medium 31 formed by laminating support 12, recording layer 13, reflective layer 14 and protective layer 15 in this order is bonded with a one surface optical recording medium 32 formed by laminating support 22, recording layer 23, reflective layer 24 and protective layer 25 in this order in such a way that respective protective layers 15 and 25 face to each other via adhesive layer 50. In other words, the optical recording medium 1 has such a structure that the support 12, recording layer 13, reflective layer 14, protective layer 15, adhesive layer 50, protective layer 25, reflective layer 24, recording layer 23 and support 22 are laminated in the order from the bottom side in the drawing. Further, on each surface of supports 12 and 22 facing to recording layers 13 and 23, chamfer-like grooves 123 and 223 are formed respectively.

Hereinafter, description will be given about a production method of optical recording medium 10 having such structure. As described above, the optical recording medium 10 has been formed by bonding the one surface optical recording medium 31 and the one surface optical recording medium 32, in which respective one face optical recording media may be produced in the same way. Here, description will be given while using a production method of the one face optical recording medium 31 as an example.

In the production of the one face optical recording medium 31, firstly, support 12 is prepared. The support 12 is a material having a disk-like shape with a diameter of around 64-200 mm and thickness of around 0.6 mm. As for such support 12, since recording light and reproducing light are irradiated to recording layer 13 formed inside the support 12 upon writing and reading for the optical recording medium 10, preferably the support 12 is substantially transparent for these light. More specifically, transmittance of the support 12 for recording light and reproducing light is preferably 88% or more. As for a material of the support 12 that satisfies such condition, resin or glass that satisfies the aforementioned condition for transmittance is preferred. Among them, thermoplastic resin such as polycarbonate resin, acrylic resin, amorphous polyolefin, TPX and polystyrene-based resin is particularly preferred.

On the surface of the support 12 facing to the recording layer 13, a chamfer-like groove 123 is formed. Such groove 123 is a continuous-type groove having a spiral shape when the support is viewed from above. The groove 123 is preferred when it has a depth of 60-200 nm, a width of 0.2-0.5 μm and a groove pitch of 0.6-1.0 μm. Such structure of the groove 123 can give good tracking signal without lowering a reflection level at the groove.

The groove 123 may be formed at the same time when the support 12 is molded by performing injection molding or the like by using the aforementioned resin. Or, it may be formed by a process in which a planar support 12 is formed, then a resin layer having a concave portion to be the groove 123 is formed by a 2P method or the like, and a composite support is made from the support 12 and such resin layer.

Next, on the surface of the support 12 on which the groove 123 has been formed, the coating liquid of the aforementioned embodiment is coated to form the recording layer 13. Upon formation of the recording layer 13, a drying process for removing the solvent may be performed according to need after coating of the aforementioned coating liquid. The coating of the coating liquid may be practiced by a spin coat method, a gravure coat method, a spray coat method, a dip coat method or the like. Among them, a spin coat method that simply enables practice of coating with a uniform thickness is preferred.

The coating of the coating liquid is performed so as to give a dried thickness of 50-200 nm preferably, and 70-150 nm more preferably to the recording layer 13. A thickness of the recording layer 13 outside of this range tends to lower a reflectivity for reproducing light, making practice of good reproduction difficult.

The recording layer 13 formed in this way becomes a layer mainly constituted of pigment comprising mainly the compound represented by the aforementioned general formula (1). Here, in the layer 13, TFP and/or OFP or an aliphatic saturated alcohol included in the coating liquid may remain by around 30 μg per one recording layer 13. Since the recording layer 13 has been formed by coating the coating liquid of the invention that is extremely excellent in wettability for the support 12, it becomes a layer formed in a uniform thickness on the surface of the support 12 having such a concave portion as the groove 123.

Specifically, according to the aforementioned coating liquid, difference between thickness of the recording layer 13 formed in the groove 123 and thickness of the recording layer formed on surface of the other portion of the support 12 (so-called “land portion”), that is, a leveling ratio falls in a preferable range. Here, a leveling ration means a value that satisfies the relation represented by “leveling ratio C=[thickness D_{G} (μm) of a recording layer at a groove−thickness D_{L} (μm) of a recording layer at a land portion]/depth A (μm) of the groove.” For example, a preferable leveling ratio C for DVD±R is 0.1-0.4, more preferably 0.2-0.3. A leveling ratio C less than 0.1 tends to make it difficult to obtain a sufficient reflectivity and modulation degree. On the other hand, a leveling ratio more than 0.4 tends to degrade the property for fluctuation of reproduced signal in time direction (jitter), or to lower a reflectivity. That is, when the leveling ratio is in the aforementioned range, jitter is reduced, in addition to enhancement of balance between a reflectivity and modulation degree.

In this relation, the coating liquid of the invention has very good wettability for the support 12 as described above. Therefore, the recording layer 13 is formed such that excellent coverage can be obtained across the land portion to the groove portion. As the result, in the recording layer 13, difference between D_{G} and D_{L} becomes small, thereby generally leading to satisfy a leveling ratio lying in the aforementioned preferred range.

It is preferred that an extinction coefficient (imaginary part k of the complex refractive index) for recording light and reproducing light for the recording layer 13 formed by coating of the coating liquid is 0-0.20. When an extinction coefficient exceeds 0.20, obtaining a sufficient reflectivity tends to become difficult. Further, a refractive index (real part n of the complex refractive index) of the recording layer 13 is preferably 1.8 or more. A refractive index less than 1.8 tends to make modulation degree of signal small. In this connection, the upper limit of the refractive index is not particularly limited but, usually, is around 2.6 for convenience of synthesis of the organic pigment.

Here, the extinction coefficient and refractive index of the recording layer 13 can be obtained according to the following procedure. First, a recording layer is provided in a thickness of around 40-100 nm on a predetermined transparent support to prepare a measuring sample, then a reflectivity through the support or a reflectivity from the recording layer side is measured for the measuring sample to give them. In this case, the reflectivity is measured at specular reflection (around 5 degrees) using the wavelength of recording/reproducing light. Further, the transmittance of the sample is measured. From these measured values, then, the extinction coefficient and refractive index can be calculated according to the method described in, for example, Ishiguro Kozo, “Optics” p 168-178, Kyoritsu Zensho.

After forming the recording layer 13 in this way, the reflective layer 14 is formed on the surface of the side opposite to the support 12 in the recording layer 13. The reflective layer 14 may be formed by using a metal or alloy with a high reflectivity and depositing these through vacuum evaporation, sputtering or the like. As for the metal or alloy for forming the reflective layer 14, gold (Au), copper (Cu), aluminum (Al), silver (Ag), AgCu and the like can be mentioned. The reflective layer 14 is formed, preferably, so as to have a thickness of 50-120 nm.

After that, a coating liquid for forming a protective layer comprising such materials as ultraviolet-curing resin and the like is coated on the surface of the side opposite to the support 12 in the reflective layer 14 to form the protective layer 15 with drying the coated film if necessary, thereby giving the one face optical recording medium 31. The protective layer 15 thus formed becomes a body having a shape of a layer or sheet, in which a thickness of 0.5-100 μm is preferred. Coating of a coating liquid for forming a protective layer can be practiced by a spin coat method, a gravure coat method, a spray coat method, a dip coat method or the like, as is the case for forming the recording layer 13.

The one face optical recording medium 32 may be obtained in the same way as that for the aforementioned one face optical recording medium 31. Then, the obtained two one face optical recording media 31 and 32 are bonded in such a state that respective protective layers 15 and 25 face to each other, by using a publicly known adhesive. This gives the optical recording medium 10 in which the one face optical recording medium 31 and the one face optical recording medium 32 are bonded via the adhesive layer 50.

Hereinafter, description will be given about recording (writing) and reproducing (reading) methods of data in which the thus obtained optical recording medium 10 is used. That is, upon performing writing of data, light (such as laser light) having a predetermined wavelength (for example, 620-690 nm in the case of DVD±R) is irradiated to the optical recording medium 10 from the side of support 12 or support 22. The irradiated light passes through the support 12 or 22 to reach the recording layer 13 or 23. A light-irradiated portion of respective recording layers 13 and 23 is heated to form a pit at the portion chemically or physically. Thus, data are written to the recording layer 13 or 23.

Next, upon reproduction of data from the optical recording medium 10 to which data has been written, light of the wavelength same as that used at recording is irradiated from the side of support 12 or 22. The irradiated light reaches the recording layer 13 to be reflected there. On this occasion, since respective portions, where pit has been formed or not on the surface in the recording layers 13 and 23, are different in reflectivity, data written to the recording layer 13 or 23 can be read out on the basis of such difference in the reflectivity.

As mentioned above, the optical recording medium 10 is obtained by using the aforementioned coating liquid of the embodiment to form the recording layers 13 and 23. According to the optical recording medium 10 thus obtained, actions and advantages represented below can be obtained. That is, first, the recording layers 13 and 23 are mainly formed of pigment comprising the compound represented by the aforementioned general formula (1). Such compound is extremely excellent in properties of dispersing heat after the heating. Accordingly, even when writing to the recording layer 13 or 23 is performed while rotating the optical recording medium 10 at a high speed, remaining heat of a previously formed pit hardly remains. Therefore, it becomes possible to reduce considerably recording mistake based on the thermal interference.

Further, the compound represented by the aforementioned general formula (1) in the recording layers 13 and 23 has extremely high properties of absorbing the recording light, especially laser light for a large capacity recording medium such as DVD±R having a wavelength of near 620-690 nm. Therefore, the optical recording medium 10 becomes one having a property of extremely high sensitivity at writing, in addition to enabling high density recording using a laser light of such waveband. Furthermore, although conventionally used pigments have very low endurance (light stability) against a laser light having such wavelength, the pigment comprising the aforementioned compound has sufficient light stability against the laser light having such wavelength. Therefore, the optical recording medium 10 shows considerably low degradation of the recording layers 13 and 23 due to writing compared with conventional ones to exert excellent reliability.

Furthermore, the recording layer 13 of the optical recording medium 10 has been formed on the surface of the supports 12 and 22 having the grooves 123 and 223, respectively, with a uniform thickness, as described above. Although pits at writing are often formed on the recording layer 13 located at the bottom of groove, the recording layer 13 has been formed uniformly inside the groove in the optical recording medium 10, as described above, thereby leading to generation of accurate reflection of the laser light at reproduction. Therefore, according to the optical recording medium 10, recorded data can be read out accurately.

Still furthermore, the coating liquid for forming the recording layer 10 is extremely excellent in wettability for the supports 12 and 22, as described above. Therefore, even when a small volume of the coating liquid is used, coating defect or the like generates hardly. As the result, for the optical recording medium 10, production cost becomes lower compared with that for conventional optical recording media.

In this connection, the optical recording medium obtained according to the production method of the invention is not limited to one formed according to the aforementioned embodiment, only when a recording layer thereof has been formed by using the coating liquid of the invention. For example, it not necessarily is an optical recording medium suitable for the wavelength for DVD±R, but can be formed as a recording medium suitable for light having a different wavelength by suitably adjusting structure of pigment, ingredient to be mixed, or the like.

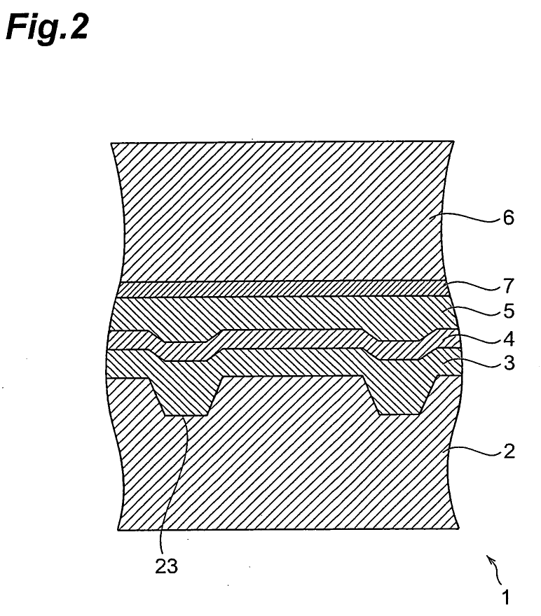

Also, the optical recording medium not necessarily is in the aforementioned mode in which two one face optical recording media are bonded, but may be in a shape of independent one face recording medium. FIG. 2 is a drawing representing an optical recording medium in this mode, in other words, a cross-sectional structure of an optical recording medium provided with a recording layer on one face of a support. Optical recording medium 1 shown in FIG. 2 has such a structure that recording layer 3, reflective layer 4, protective layer 5, adhesive layer 7 and dummy support 6 are laminated on support 2 in this order. On the surface of the side facing to the recording layer 3 in the support 2, a chamfer-like groove 23 is formed.

In this way, in the optical recording medium 1, the dummy support 6 is adhered on the protective layer 5 via the adhesive layer 7, thereby leading to a structure that can assure sufficient strength with a mode of a one face optical recording medium. The optical recording medium 1 having the aforementioned constitution can be formed by forming a laminate provided with the support 2, recording layer 3, reflective layer 4 and protective layer 5 in the same way as production of the aforementioned one face optical recording medium 31, followed by adhering the dummy support 6 on the protective layer 5 via the adhesive layer 7.

Further, the aforementioned optical recording medium 1 or one face recording medium 31 or 32 in the optical recording medium 10 is not required to have such a mode that single recording layer is provided on respective supports, but may have such a mode that plural recording layers are provided. In this case, inclusion of respective pigments different from each other in plural recording layers provided on the support enables performance of recording/reproducing respective data for respective layers by using plural recording/reproducing light having the same or different wavelength, thereby making further high-capacity recording possible. In this connection, in an optical recording medium of such mode, a reflection coating that is translucent for recording/reproducing light may be provided on respective recording layers.

### EXAMPLES

Hereinafter, the present invention will be described in further detail based on Examples, but the invention is not intended to be limited to these Examples.

[Preparation of Coating Liquid]

### Examples 1-8

A cyanine-based compound represented by the aforementioned general formula (1) and a chelate compound were dissolved in a mixed solvent of 2,2,3,3-tetrafluoro propanol (TFP) and an aliphatic saturated alcohol to prepare coating liquids of Examples 1-8. Kind and compounding ratio of the cyanine-based compound and chelate compound, and kind of the aliphatic saturated alcohol and a compounding ratio thereof to TFP are determined as shown in Table 7, respectively. Further, the total content of the cyanine-based compound and chelate compound was determined to give 1.5% by mass in the total amount of the coating liquid.

### Comparative Examples 1-5

Coating liquids for Comparative Examples 1-5 were prepared in the same way as Examples 1-8, except for using no aliphatic saturated alcohol, using a mixed solvent in which content of an aliphatic saturated alcohol was outside the range of 0.01-10% by mass, or using a mixed solvent incorporated with ethylcellosolve in place of an aliphatic saturated alcohol by a mass ratio as shown in Table 7. Here, each designation of cyanine-based compounds and chelate compounds corresponds to number of the chemical formula described in the specification.

TABLE 7

| Coating | Cyanine-based | Chelate compound | Solvent (TFP:aliphatic |
|---|---|---|---|
| liquid | compound (mol ratio) | (mol ratio) | saturated alcohol (mass ratio)) |
| Example 1 | Chemical formula (7d) (85) | A3 (15) | TFP:ethanol = 99:1 |
| Example 2 | Chemical formula (10a) (80) | A10 (20) | TFP:2-propanol = 95:5 |
| Example 3 | Chemical formula (14b) (95) | A13 (5) | TFP:methanol = 99:1 |
| Example 4 | Chemical formula (7f) (60) | A16 (40) | TFP:ethanol = 98:2 |
| Example 5 | Chemical formula (10e) (40) | A17 (60) | TFP:1-propanol = 96:4 |
| Example 6 | Chemical formula (5a) (80) | A25 (20) | TFP:methanol = 98:2 |
| Example 7 | Chemical formula (8a) (85) | A33 (15) | TFP:ethanol = 93:7 |
| Example 8 | Chemical formula (12) (90) | A42 (10) | TFP:1-propanol = 95:5 |
| Comparative | Chemical formula (14a) (70) | A6 (30) | TFP |
| Example 1 | | | |
| Comparative | Chemical formula (14a) (70) | A6 (30) | TFP:ethylcellosolve = 95:5 |
| Example 2 | | | |
| Comparative | Chemical formula (14a) (70) | A6 (30) | TFP:methylcellosolve = 99:1 |
| Example 3 | | | |
| Comparative | Chemical formula (14a) (70) | A6 (30) | TFP:1-propanol = 80:20 |
| Example 4 | | | |
| Comparative | Chemical formula (11a) (50) | A21 (50) | TFP:2-propanol = 85:15 |
| Example 5 | | | |

[Production of Optical Recording Medium]

### Example 9

The coating liquid in Example 1 was coated by a spin coat method on a polycarbonate resin support of 120 mm in diameter and 0.6 mm in thickness to give a thickness of 140 nm, followed by drying to form a recording layer.

Next, on the recording layer, a reflective layer consisting of Ag was formed by a sputtering method. Thickness of the reflective layer was determined to be 100 nm. Then, an ultraviolet-curing type acrylic resin was coated on the reflective layer by a spin coat method so as to have a thickness of 5 μm, followed by irradiating ultraviolet ray to cure the same, thereby forming a protective layer. Then, a dummy support (a polycarbonate resin support of 0.6 mm in thickness) was adhered to the protective layer via an adhesive layer to give an optical recording medium having the structure as shown in FIG. 2.

### Examples 10-16, Comparative Examples 6-10

Optical recording media of Examples 10-16 and Comparative Examples 6-10 were produced in the same way as Example 9, except for using respective coating liquids in Examples 2-8 and Comparative Examples 1-5 in place of the coating liquid in Example 1.

[Evaluation of Sensitivity, Reflectivity and Jitter]

Evaluation of the sensitivity, reflectivity and jitter was performed using optical recording media in Examples 9-16 and Comparative Examples 6-10. That is, DDU-1000 manufactured by Pulstec Industrial Co., Ltd. was used to irradiate a laser light having a wavelength of 655 nm to the recording layer to form pits and, at the same time, reflected light of the irradiated laser light was detected to measure recording power (laser output (mW)) required for writing and the reflectivity (%) of the laser light. Also, the jitter was measured for respective optical recording media having been thus subjected to writing upon performing reproduction by irradiating a laser light having a wavelength of 650 nm.

In this connection, in every measurement, the optical recording medium was rotated at a rate corresponding to 16 times that at writing of DVD±R. Results obtained by using respective optical recording media are listed collectively in Table 8. A smaller power required for writing means a higher sensitivity of the recording layer.

TABLE 8

| Optical recording | Recording | Reflectivity | |
|---|---|---|---|
| medium | power (mW) | (%) | Jitter |
| Example 9 | 39.3 | 48.3 | 6.7 |
| Example 10 | 42.6 | 48.5 | 7 |
| Example 11 | 43.9 | 49.9 | 7.9 |
| Example 12 | 39.7 | 46.8 | 7.3 |
| Example 13 | 37.5 | 45.1 | 7.1 |
| Example 14 | 38.1 | 49.2 | 7.5 |
| Example 15 | 37.8 | 45.9 | 6.9 |
| Example 16 | 40.2 | 50.5 | 7.4 |
| Comparative | 45.7 | 38.5 | 8.4 |
| Example 6 | | | |
| Comparative | 48.9 | 38.9 | 8.7 |
| Example 7 | | | |
| Comparative | 47.2 | 35.2 | 8.2 |
| Example 8 | | | |
| Comparative | 46.2 | 40.5 | 8.5 |
| Example 9 | | | |
| Comparative | 47.6 | 40.9 | 8.6 |
| Example 10 | | | |

From Table 8, such result was obtained that optical recording media in Examples 9-16 obtained by using coating liquids (Examples 1-8) which comprise a mixed solvent containing TFP and a predetermined amount of aliphatic saturated alcohol having 1-4 carbon atoms can be written by a lower power, have a higher reflectivity and, in addition, have a smaller jitter, compared with optical recording media obtained by using coating liquids (Comparative Examples 1-5) which comprise a solvent without an aliphatic saturated alcohol or a solvent whose content of the aliphatic saturated alcohol is outside the range of 0.01-10% by mass. From this, it was revealed that the optical recording medium obtained by using the coating liquid of the invention enables writing with a sufficient sensitivity even when it is rotated at a higher rate (corresponding to 16 times rate) than conventional one. Further, it was also revealed that reading (reproduction) of recorded data can be performed easily because of a high reflectivity thereof.

[Preparation of Coating Liquid]

### Examples 17-24

Coating liquids in Examples 17-24 were prepared in the same way as Examples 1-8, except for using 2,2,3,3,4,4,5,5-octafluoro-1-pentanol (OFP) in place of TFP. Kind and compounding ratio of the cyanine-based compound and chelate compound, and kind of the aliphatic saturated alcohol and a compounding ratio thereof to TFP were determined to those, respectively, as listed in Table 9. Further, the total content of the cyanine-based compound and chelate compound was determined to give 1.5% by mass in the total amount of the coating liquid.

### Comparative Examples 11-15

Coating liquid for Comparative Examples 11-15 were prepared in the same way as Examples 17-24, except for using no aliphatic saturated alcohol, using a mixed solvent in which content of an aliphatic saturated alcohol was outside the range of 0.01-10% by mass, or using a mixed solvent incorporated with ethylcellosolve in place of an aliphatic saturated alcohol by a mass ratio as shown in Table 9. Here, each designation of cyanine-based compounds and chelate compounds corresponds to number of the chemical formula described in the specification.

TABLE 9

| Coating | Cyanine-based | Chelate compound | Solvent (OFP:aliphatic |
|---|---|---|---|
| liquid | compound (mol ratio) | (mol ratio) | saturated alcohol (mass ratio)) |
| Example 17 | Chemical formula (7d) (85) | A3 (15) | OFP:ethanol = 99:1 |
| Example 18 | Chemical formula (10a) (80) | A10 (20) | OFP:2-propanol = 95:5 |
| Example 19 | Chemical formula (14b) (95) | A13 (5) | OFP:methanol = 99:1 |
| Example 20 | Chemical formula (7f) (60) | A16 (40) | OFP:ethanol = 98:2 |
| Example 21 | Chemical formula (10e) (40) | A17 (60) | OFP:1-propanol = 96:4 |
| Example 22 | Chemical formula (5a) (80) | A25 (20) | OFP:methanol = 98:2 |
| Example 23 | Chemical formula (8a) (85) | A33 (15) | OFP:ethanol = 93:7 |
| Example 24 | Chemical formula (12) (90) | A42 (10) | OFP:1-propanol = 95:5 |
| Comparative | Chemical formula (14a) (70) | A6 (30) | OFP |
| Example 11 | | | |
| Comparative | Chemical formula (14a) (70) | A6 (30) | OFP:ethylcellosolve = 95:5 |
| Example 12 | | | |
| Comparative | Chemical formula (14a) (70) | A6 (30) | OFP:methylcellosolve = 99:1 |
| Example 13 | | | |
| Comparative | Chemical formula (14a) (70) | A6 (30) | OFP:1-propanol = 80:20 |
| Example 14 | | | |
| Comparative | Chemical formula (11a) (50) | A21 (50) | OFP:2-propanol = 85:15 |
| Example 15 | | | |

[Production of Optical Recording Medium]

### Examples 25-32 and Comparative Examples 16-20

Optical recording media in Examples 25-32 and Comparative Examples 16-20 were produced in the same way as Example 9, except for using coating liquids in Examples 17-24 and Comparative Examples 11-15, respectively, in place of the coating liquid in Example 1.

[Evaluation of Sensitivity, Reflectivity and Jitter]

Optical recording media in Examples 25-32 and Comparative Examples 16-20 were used to measure the sensitivity, reflectivity and jitter of respective optical recording media according to the method similar to that described above. The obtained results are listed collectively in Table 10.

TABLE 10

| Optical recording | Recording | Reflectivity | |
|---|---|---|---|
| medium | power (mW) | (%) | Jitter |
| Example 25 | 39.8 | 45.1 | 7.4 |
| Example 26 | 41.8 | 48.7 | 7.4 |
| Example 27 | 39.3 | 49.8 | 7.9 |
| Example 28 | 40.4 | 50.1 | 7.3 |
| Example 29 | 38.9 | 49.7 | 6.9 |
| Example 30 | 42.5 | 46.5 | 7.5 |
| Example 31 | 38.1 | 49.3 | 8.0 |
| Example 32 | 37.9 | 47.9 | 7.7 |
| Comparative | 46.3 | 38.5 | 8.1 |
| Example 16 | | | |
| Comparative | 45.9 | 38.9 | 8.4 |
| Example 17 | | | |
| Comparative | 48.1 | 35.2 | 8.3 |
| Example 18 | | | |
| Comparative | 46.2 | 36.7 | 8.7 |
| Example 19 | | | |
| Comparative | 47.3 | 37.5 | 8.9 |
| Example 20 | | | |

From Table 10, it was revealed that, as is the case for using a mixed solvent comprising TFP, the optical recording media obtained by using respective coating liquids (Examples 17-24) that comprise a mixed solvent containing OPF and a predetermined amount of aliphatic saturated alcohol having 1-4 carbon atoms also enables writing with a sufficient sensitivity even when they are rotated at a high rate (16 times rate). Further, it was revealed that reading (reproduction) of recorded data can be performed easily because of a high reflectivity thereof.

As described above, according to the coating liquid of the invention, it becomes possible to obtain an optical recording medium that has low property degradation due to coating defect or unevenness of thickness, can reduce considerably the writing mistake caused by the thermal interference upon trying a high speed recording, and further is excellent also in sensitivity and reflectivity. Further, according to the invention, it becomes possible to provide a method for producing an optical recording medium using such coating liquid, and an optical recording medium obtained by the production method.

1. A coating liquid for forming a recording layer of an optical recording medium comprising:
a solvent; and
a pigment dissolved in the solvent, wherein:
the solvent comprises tetrafluoro propanol and/or octafluoro pentanol and an aliphatic saturated alcohol having 1-4 carbon atoms by 0.01-10% by mass relative to the total amount of the solvent, and
the pigment comprises a compound represented by the following general formula (1) and a chelate compound consisting of an azo compound and a metal. 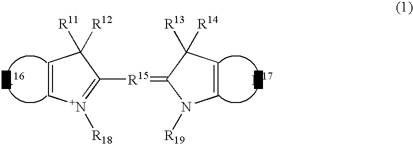
[where, each of R¹¹, R¹², R¹³ and R¹⁴ represents independently from one another a benzyl group that may have a substituent or an alkyl group having 1-4 carbon atoms, R¹⁵ represents a trimethine chain that may have a substituent, each of R¹⁶ and R¹⁷ represents independently from each other a group of atoms that constitute a benzene ring that may have a substituent or a naphthalene ring that may have a substituent, and each of R¹⁸ and R¹⁹ represents independently from each other an aryl group that may have a substituent or an alkyl group having 1-4 carbon atoms, provided that at least one group among R¹¹, R¹², R¹³ and R¹⁴ is not a methyl group. In this case, respective carbons of R¹¹ and R¹² and/or R¹³ and R¹⁴ may make a bond to form a 3- to 6-membered ring.]

2. The coating liquid according to claim 1, wherein the aliphatic saturated alcohol is isopropyl alcohol.

3. The coating liquid according to claim 1, wherein at least one group of the R¹¹, the R¹², the R¹³ and the R¹⁴ is a benzyl group that may have a substituent.

4. A method for producing an optical recording medium, comprising:
the step of coating a coating liquid comprising a solvent and a pigment dissolved in the solvent on a support, wherein
a solvent comprising tetrafluoro propanol and/or octafluoro pentanol and an aliphatic saturated alcohol having 1-4 carbon atoms by 0.01-10% by mass relative to the total amount of the solvent is used as the solvent, and
a pigment comprising a compound represented by the following general formula (1) and a chelate compound consisting of an azo compound and a metal is used as the pigment. 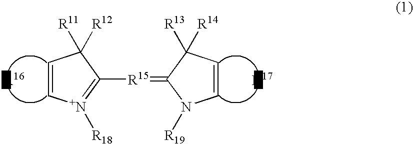
[where, each of R¹¹, R¹², R¹³ and R¹⁴ represents independently from one another a benzyl group that may have a substituent or an alkyl group having 1-4 carbon atoms, R¹⁵ represents a trimethine chain that may have a substituent, each of R¹⁶ and R¹⁷ represents independently from each other a group of atoms that constitute a benzene ring that may have a substituent or a naphthalene ring that may have a substituent, and each of R¹⁸ and R¹⁹ represents independently from each other an aryl group that may have a substituent or an alkyl group having 1-4 carbon atoms, provided that at least one group among R¹¹, R¹², R¹³ and R¹⁴ is not a methyl group. In this case, respective carbons of R¹¹ and R¹² and/or R¹³ and R¹⁴ may make a bond to form a 3- to 6-membered ring.]

5. The method for producing an optical recording medium according to claim 4, wherein the aliphatic saturated alcohol is isopropyl alcohol.

6. The method for producing an optical recording medium according to claim 4, wherein at least one group of the R¹¹, the R¹², the R¹³ and the R¹⁴ is a benzyl group that may have a substituent.

7. An optical recording medium comprising:
a support; and
a recording layer disposed on the support, wherein
the recording layer has been formed through a process of coating a coating liquid comprising
a solvent and a pigment dissolved in the solvent on the support, wherein
a solvent comprising tetrafluoro propanol and/or octafluoro pentanol and an aliphatic saturated alcohol having 1-4 carbon atoms by 0.01-10% by mass relative to the total amount of the solvent is used as the solvent, and
a pigment comprising a compound represented by the following general formula (1) and a chelate compound consisting of an azo compound and a metal is used as the pigment. 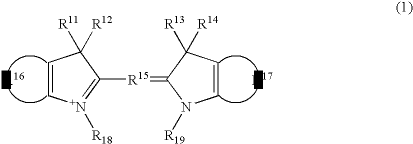
[where, each of R¹¹, R¹², R¹³ and R¹⁴ represents independently from one another a benzyl group that may have a substituent or an alkyl group having 1-4 carbon atoms, R¹⁵ represents a trimethine chain that may have a substituent, each of R¹⁶ and R¹⁷ represents independently from each other a group of atoms that constitute a benzene ring that may have a substituent or a naphthalene ring that may have a substituent, and each of R¹⁸ and R¹⁹ represents independently from each other an aryl group that may have a substituent or an alkyl group having 1-4 carbon atoms, provided that at least one group among R¹¹, R¹², R¹³ and R¹⁴ is not a methyl group. In this case, respective carbons of R¹¹ and R¹² and/or R¹³ and R¹⁴ may make a bond to form a 3- to 6-membered ring.]

8. The coating liquid according to claim 2, wherein at least one group of the R¹¹, the R¹², the R¹³ and the R¹⁴ is a benzyl group that may have a substituent.

9. The method for producing an optical recording medium according to claim 5, wherein at least one group of the R¹¹, the R¹², the R¹³ and the R¹⁴ is a benzyl group that may have a substituent.
